(19) United States
(12) Patent Application Publication
(10) Pub. No.: US 2015/0285459 A1
(43) Pub. Date: Oct. 8, 2015

(54) PRIMARY OPTIC LENS AND LAMP FOR VEHICLE HAVING THE SAME

(71) Applicant: Hyundai Mobis Co., Ltd., Seoul (KR)

(72) Inventor: Dong Gon KANG, Yongin-si (KR)

(21) Appl. No.: 14/659,287

(22) Filed: Mar. 16, 2015

(30) Foreign Application Priority Data
Apr. 8, 2014 (KR) 10-2014-0041843

(51) Int. Cl. F21V 5/04; F21V 5/00; F21V 29/70; F21S 8/10; F21V 7/22

(52) U.S. Cl. CPC F21V 5/04; F21S 48/00; F21V 7/22; F21V 29/70; F21V 5/008; F21Y 2101/02

(57) ABSTRACT

A primary optic lens including: a first lower end surface that transmits light emitted from the light source; a first upper end surface having an inward recessed shape opposed to the first lower end surface and reflecting light transmitted from the first lower end surface; a second upper end surface connected to the first upper end surface and again reflects light reflected by the first upper end surface; and a second lower end surface connecting the second upper end surface with the first lower end surface.

### CROSS-REFERENCE TO RELATED APPLICATIONS

This application claims priority from and the benefit of Korean Patent Application No. 10-2014-0041843, filed on Apr. 8, 2014, which is hereby incorporated by reference for all purposes as if fully set forth herein.

### BACKGROUND

1. Field

Exemplary embodiments relate to a primary optic lens and a lamp for a vehicle having the same. More particularly, exemplary embodiments relate to a primary optic lens, which is provided in front of a light source so as to implement a surface light source technology, and a lamp for a vehicle having the primary optic lens.

2. Discussion of the Background

In general, a vehicle has a lighting system in order to allow a driver to easily confirm the presence of objects positioned in a traveling direction when the vehicle travels at night, and to inform drivers of other vehicles or other users, who use a road, of a driving state of a host vehicle. The lamps for a vehicle include lamps having various functions in addition to head lamps that illuminate a path at a front side of the vehicle in a direction in which the vehicle travels, tail lamps that inform a following vehicle of a position of the host vehicle when the vehicles travel at night, and brake lamps that inform the following vehicle of a deceleration state of the host vehicle.

Regarding the lamp for a vehicle, a light source has been developed from a point-type light source into a line-type light source, and recently, the light source has been developed into a surface-type light source for emitting surface-type light.

FIG. 1 illustrates a structure of an optical system in the related art which implements a surface-type light source.

Referring to FIG. 1, a structure 1 of an optical system, which implements a surface-type light source 3, includes a light emitting diode (LED) provided on a circuit board (PCB) 4, and a reflector 5 disposed in front of the light source 3. The reflector 5 typically has a curved shape, and reflects light toward a front lens 2 of a lamp.

The light source has been developed into the surface-type light source having the aforementioned shape in response to design trends of the lamp for a vehicle. However, the surface light source having the aforementioned structure typically utilizes a number of LEDs, and uses a light diffusion agent on a reflective surface in order to implement a uniform image of emitted light. As a result, there is a problem in that energy efficiency in using light is extremely low. A high-cost structure, which is caused by the aforementioned problem, acts as a hindrance in extending the market of LED lamps.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a surface light source with a small number of LEDs by using a primary optic lens.

Exemplary embodiments of the present invention also provide cost reduction for LED lamps for a vehicle by reducing the number of LEDs, and an improved fuel efficiency of the vehicle by reducing power consumption of the LEDs.

Additional aspects will be set forth in the detailed description which follows, and, in part, will be apparent from the disclosure, or may be learned by practice of the inventive concept.

An exemplary embodiment of the present invention discloses a primary optic lens including: a first lower end surface that transmits light emitted from the light source; a first upper end surface having an inward recessed shape opposing the first lower end surface and reflecting light transmitted from the first lower end surface; a second upper end surface connected to the first upper end surface and again reflecting light reflected by the first upper end surface; and a second lower end surface connecting the second upper end surface with the first lower end surface.

An exemplary embodiment of the present invention also discloses a lamp for a vehicle having a primary optic lens, the lamp including: a light source; a substrate on which the light source is seated; and a primary optic lens positioned on a line along which light is emitted from the light source.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a cross-sectional view illustrating a structure of an optical system in the related art which implements a surface-type light source.

FIG. 2 is a perspective view of a primary optic lens according to an exemplary embodiment of the present invention.

FIG. 3 is a cross-sectional view illustrating light reflection when a light entering portion provided in the primary optic lens according to the exemplary embodiment of the present invention has a parabolic shape.

FIG. 4 is a cross-sectional view illustrating light reflection when the light entering portion provided in the primary optic lens according to the exemplary embodiment of the present invention has a convex shape.

FIG. 5 is a cross-sectional view of a lamp for a vehicle, which has the primary optic lens according to the exemplary embodiment of the present invention.

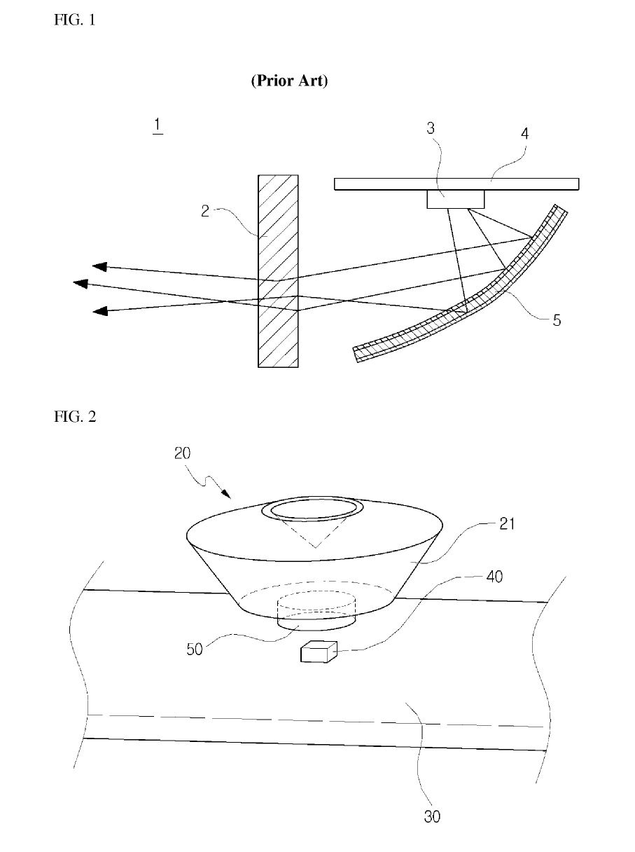

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings.

Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Referring to FIG. 2 to FIG. 4, a primary optic lens 20 is positioned on a line along which light is emitted from a light source 40.

The primary optic lens 20 includes a first lower end surface 28 that transmits light emitted from the light source 40, a first upper end surface 22, which has an inward recessed shape opposing the first lower end surface 28 and reflects light transmitted from the first lower end surface 28, a second upper end surface 24 that is connected to the first upper end surface 22 and reflects again light reflected by the first upper end surface 22, and a second lower end surface 27 that connects the second upper end surface 24 with the first lower end surface 28.

The first lower end surface 28 allows light emitted from the light source 40 to pass through the first lower end surface 28. The first lower end surface 28 may be formed to have a flat surface, and may have various shapes, such as a circular shape or an elliptical shape.

The first upper end surface 22 is recessed toward the inside of the primary optic lens 20, and reflects light passing through the first lower end surface 28 toward the second upper end surface 24. The first upper end surface 22 may totally reflect light reflected by the first lower end surface 28. In a case in which the first upper end surface 22 totally reflects light, the first upper end surface 22 may include a coating of a reflective material in order to totally reflect light passing through the first lower end surface 28, or by using a critical angle of reflected light.

In one exemplary embodiment, the first upper end surface 22 may have an inward recessed conical shape, a circular truncated conical shape, or a shape of a body of revolution which is formed by rotating any curved line about a central axis c. In a case in which the first upper end surface 22 has a conical shape or a circular truncated conical shape, an interior angle between the first upper end surface 22 and the central axis c may be 48 degrees or less, and an incidence angle is greater than the critical angle, thereby totally reflecting light that enters the first upper end surface 22.

The second upper end surface 24 connects the first upper end surface 22 with the second lower end surface 27, and reflects light reflected with the first upper end surface 22.

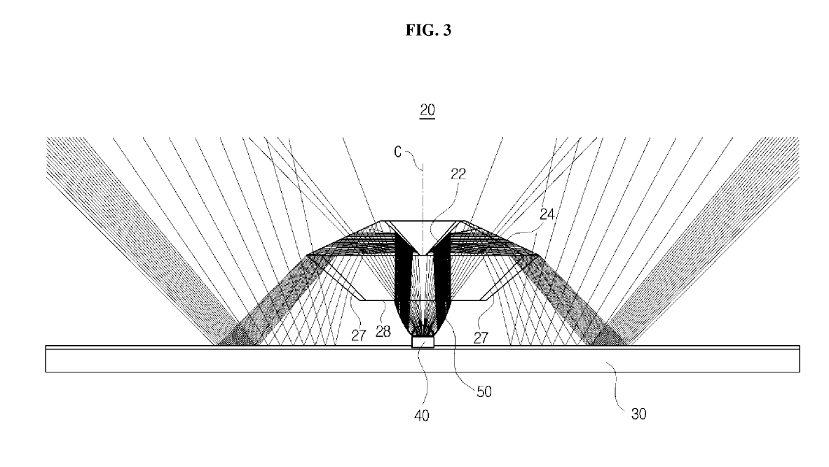

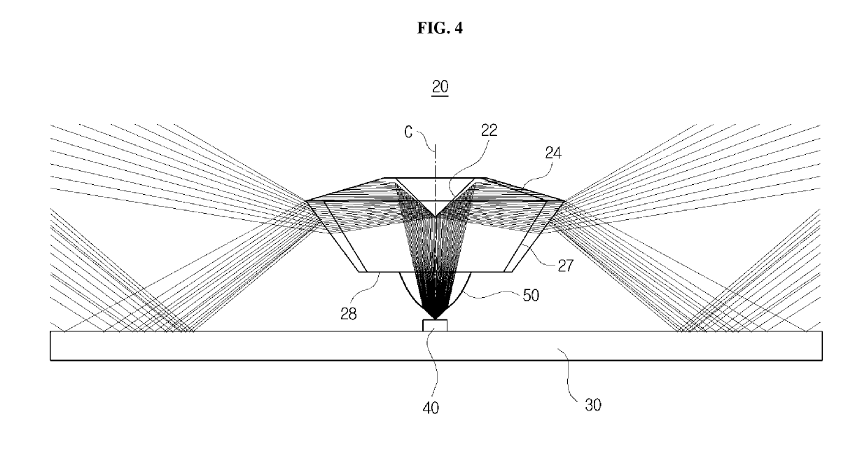

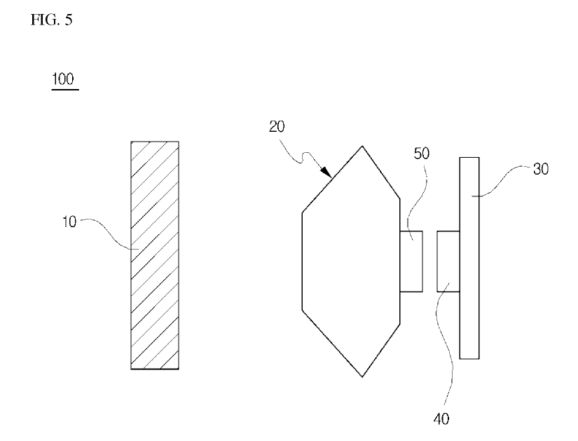

The second upper end surface 24 may have a shape of a body of revolution that is formed by rotating a straight line or any curved line about the central axis c. Referring to FIG. 4, in a case in which the second upper end surface 24 has a straight-line shape, the second upper end surface 24 may serve to reflect light downward while totally reflecting light reflected by the first upper end surface 22. Referring to FIG. 3, in a case in which the second upper end surface 24 has a shape of a body of revolution formed by rotating a curved line, it is possible to adjust a part of the reflected light to be directed toward the upper end by adjusting curvature of the curved line.

The second lower end surface 27 connects the second upper end surface 24 with the first lower end surface 28.

In a case in which light reflected by the first upper end surface 22 directly reaches the second lower end surface 27, light travels upward by refraction. Light, which is reflected by the second upper end surface 24 and then reaches the second lower end surface 27, passes through the second lower end surface 27 and travels in a direction opposite to a direction in which light enters.

A light entering portion 50 is positioned between the light source 40 and the primary optic lens 20, and the light entering portion 50 concentrates light emitted from the light source 40.

In one exemplary embodiment, the light entering portion 50 is aligned on a line along which light is emitted from the light source 40. A portion of the light entering portion 50, where light enters, may be formed in a convex shape or a parabolic shape.

In the case of the light entering portion 50 having a parabolic shape, light generated by the light source 40 enters the light entering portion 50, is totally reflected at a side surface of the light entering portion 50, and travels straight in the same direction in which light exits from the light source 40. The side surface of the light entering portion 50 may be coated with a reflective material or the critical angle may be used, in order to totally reflect light.

The light entering portion 50, which has a convex portion where light enters, concentrates light that enters the light entering portion 50 from the light source 40. In the exemplary embodiment in which a portion where light enters has a convex shape, the convex shape may be in the form of a free curved surface, a sphere, an ellipse, or the like, and may be variously modified to have various shapes that concentrate light.

A lamp 100 for a vehicle, which has a primary optic lens 20 according to another exemplary embodiment of the present invention, will be described with reference to the accompanying drawings. However, descriptions of the same constituent elements, which have been described in the primary optic lens 20 according to the aforementioned exemplary embodiment of the present invention, will be omitted.

FIG. 5 is a cross-sectional view of a lamp for a vehicle, which has the primary optic lens according to the exemplary embodiment of the present invention. In FIG. 5, like reference numerals illustrated in FIGS. 2 to 4 indicate like members, and descriptions thereof will be omitted.

Referring to the drawings, the lamp 100 for a vehicle, which has the primary optic lens 20, includes a light source 40, a substrate 30, a light entering portion 50, a primary optic lens 20, and a light diffusion lens 10.

Various types of light sources 40 may be used within the technical field in which light is emitted. For example, a bulb, an LED, or the like may be used as the light source 40.

The light source 40 is seated on the substrate 30. For example, a PCB may be used.

In a case in which an LED is used for the light source 40, a large amount of heat is generated during a process in which electrical energy is converted into light. Because such heat degrades luminous property of the LED and shortens a lifespan of the LED, the substrate 30 may serve as a heat sink plate, and a heat sink plate (not illustrated) may be provided on a rear surface of the substrate 30.

The substrate 30 may reflect light, which is reflected by the second upper end surface 24, toward the front side of the lamp. For example, the substrate 30 may be coated with a reflective material, and may reflect light, which is reflected by the second upper end surface 24, toward the front side of the lamp.

The primary optic lens 20 is positioned on a line along which light is emitted from the light source 40, and diffuses light emitted from the light source 40 toward the front side of the lamp in order to implement the lamp having the surface light source 40.

The light entering portion 50 is positioned between the light source 40 and the primary optic lens 20, concentrates light emitted from the light source 40, and transmits the concentrated light to the primary optic lens 20. In an exemplary embodiment, the light entering portion 50 may be in contact with the first lower end surface 28 of the primary optic lens 20, and may be positioned between the light source 40 and the primary optic lens 20 by a separate support (not illustrated).

The light diffusion lens 10 allows light passing through the primary optic lens 20 to exit to the outside of the lamp. The light diffusion lens 10 may have various shapes, such as an aspherical lens and a flat lens.

According to the primary optic lens and the lamp for a vehicle having the primary optic lens, the LEDs, which were densely arranged to implement a uniform surface light source, may be arranged at longer intervals by greatly reducing, using the primary optic lens, an amount of light that is emitted from the LEDs in a normal line direction, thereby reducing the required number of LEDs.

In the present invention, by reducing the number of LEDs, it is possible to reduce costs for LED lamps for a vehicle and improve fuel efficiency by reducing power consumption of the LEDs.

Although certain exemplary embodiments and implementations have been described herein, other embodiments and modifications will be apparent from this description.

Accordingly, the inventive concept is not limited to such embodiments, but rather to the broader scope of the presented claims and various obvious modifications and equivalent arrangements.

What is claimed is:

1. A primary optic lens comprising:
a first lower end surface configured to transmit light emitted from a light source;
a first upper end surface having an inward recessed shape opposing the first lower end surface and configured to reflect light transmitted from the first lower end surface;
a second upper end surface connected to the first upper end surface and configured to again reflect light reflected by the first upper end surface; and
a second lower end surface connecting the second upper end surface with the first lower end surface.

2. The primary optic lens of claim 1, further comprising:
a light entering portion disposed between the light source and the primary optic lens, and configured to concentrate light that is emitted from the light source and enters the light entering portion.

3. The primary optic lens of claim 2, wherein a portion of the light entering portion, where light enters, has a convex shape.

4. The primary optic lens of claim 2, wherein the light entering portion has a parabolic shape.

5. The primary optic lens of claim 4, wherein light entering the lighting entering portion having the parabolic shape is totally reflected at a side surface of the parabolic shape.

6. The primary optic lens of claim 1, wherein the first upper end surface totally reflects the transmitted light.

7. The primary optic lens of claim 1, wherein the first upper end surface has a reversed conical shape.

8. The primary optic lens of claim 7, wherein the first upper end surface has an angle with respect to a central axis of 48 degrees or less.

9. The primary optic lens of claim 1, wherein the first upper end surface has a shape of a body of revolution formed by rotating a curved line.

10. The primary optic lens of claim 1, wherein the second upper end surface has a shape of a body of revolution formed by rotating a curved line.

11. A lamp for a vehicle, comprising:
a light source;
a substrate on which the light source is seated; and
a primary optic lens positioned on a line along which light is emitted from the light source.

12. The lamp of claim 11, wherein the primary optic lens comprises:
a first lower end surface configured to transmit light emitted from a light source;
a first upper end surface having an inward recessed shape opposing the first lower end surface and configured to reflect light transmitted from the first lower end surface;
a second upper end surface connected to the first upper end surface and configured to again reflect light reflected by the first upper end surface; and
a second lower end surface connecting the second upper end surface with the first lower end surface.

13. The lamp of claim 12, wherein the substrate again reflects light reflected by the second upper end surface.

14. The lamp of claim 13, wherein the substrate comprises a heat sink plate, or a heat sink plate is disposed on a rear surface of the substrate.

15. The lamp of claim 12, further comprising a light diffusion lens disposed in front of the primary optic lens.

16. The lamp of claim 11, wherein the light source comprises a light emitting diode.
